(19) United States
(12) Patent Application Publication
(10) Pub. No.: US 2015/0209218 A1
(43) Pub. Date: Jul. 30, 2015

(54) CARDIAC PACEMAKER AND DEFRIBRILLATOR COMPRESSION PAD

(71) Applicant: Lawrence Rego, Old Lyme, CT (US)

(72) Inventor: Lawrence Rego, Old Lyme, CT (US)

(21) Appl. No.: 14/566,170

(22) Filed: Dec. 10, 2014

Related U.S. Application Data
(60) Provisional application No. 61/933,098, filed on Jan. 29, 2014.

(51) Int. Cl. A61H 9/00; A61H 1/00

(52) U.S. Cl. CPC A61H 9/005; A61H 1/008; A61H 2201/0103

(57) ABSTRACT

A pressure applying apparatus is provided. The pressure applying apparatus includes a harness that is securable to an upper torso of a user. The harness includes a portion positioned to be secured over an implant of the user. An air bladder s secured to the portion. The air bladder includes a sidewall forming an internal housing where a gas is secured within. The air bladder is adjustable and thereby includes a fill hose running into the housing. The harness may be secured to the user and the air bladder may be inflated with a gas via the fill hose to apply pressure to the implant preventing hematoma.

### CROSS-REFERENCE TO RELATED APPLICATION

This application claims the benefit of priority of U.S. provisional application No. 61/933,098, filed Jan. 29, 2014, the contents of which are herein incorporated by reference.

### BACKGROUND OF THE INVENTION

The present invention relates to a harness and more particularly to an air bladder pocket with associated components for providing controlled pressure to a surgical pocket.

Pacemaker and defibrillators implantation are very common in the United Stated as well as worldwide. The procedure requires a small incision to create a pocket under the skin where the medical device is placed. The incision is then closed with the device remaining under the skin. Though the majority of implantations are safe, up to 15-17% of patients require reoperation due to bleeding into that space created. The bleeding into the pocket (hematoma) and repeated intervention increases the risk of infection and the need for removal of the device shortly after it was placed. One of the major contributor to the development of hematoma involves the need to use agents to thin the blood in a significant number of patients due to other associated medical conditions and the risk of stroke. Once a hematoma is formed, patients suffer a significant amount of pain and discomfort. They require frequent office visits and must refrain from the administration of blood thinning agents which in turn increases their risk of stroke. Conservative treatment with antibiotics and watchful waiting is undertaken, however when successful, it still takes weeks for the body to absorb the hematoma.

Currently there are a few devices which address trauma and swelling of cardiac incision sites by providing conventional cold compresses as well as moderate direct pocket compression which is adjusted by pulling an elastic and Velcro harness making it difficult to adjust properly. Though an external pressure can be applied immediately after the procedure using a heavy object or a large tape, it is often uncomfortable or its removal may be painful and in almost all cases, causes some irritation or allergic reaction. Further, these measures are usually maintained for the first 24 hours at most and in significant number of patients the hematoma develops shortly after that.

As can be seen, there is a need for an improved device for applying pressure to surgical pockets.

### SUMMARY OF THE INVENTION

In one aspect of the present invention, a pressure applying apparatus comprises: a harness securable to an upper torso of a user and comprising a portion positioned to be secured over an implantation of the user; and an air bladder secured to the portion and comprising a sidewall forming an internal housing and a fill hose running into the housing, wherein the air bladder is operable to be filled with a gas to expand the sidewall and apply pressure to the implantation.

In another aspect of the present invention, a method of preventing hematoma to an implanted device comprises: providing a harness comprising an air bladder; securing the harness to a user so that the air bladder is secured over the implanted device; and inflating the air bladder so that the air bladder applies pressure to the implanted device.

These and other features, aspects and advantages of the present invention will become better understood with reference to the following drawings, description and claims.

### BRIEF DESCRIPTION OF THE DRAWINGS

FIG. 1 is a perspective view demonstrating a pace-maker location;

FIG. 2 is a perspective view of an embodiment of the present invention shown in use;

FIG. 3 is a top perspective view of an embodiment of the present invention;

FIG. 4 is a bottom perspective view of an embodiment of the present invention;

FIG. 5 is a section detail view taken along line 5-5 in FIG. 1;

FIG. 6 is a section detail view along line 6-6 in FIG. 2; and

FIG. 7 is an exploded view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention provides a direct adjustable pressure over a surgical pocket created for insertion/implantation of cardiac pacemaker and defibrillators. The present invention may minimize the formation of hematoma after the device has been implanted and allowing initiation of blood thinner at an early stage. The best course of action in these circumstances is prevention of the hematoma and bleeding in the first place. Since the pocket is located under the skin, it is easily distensible. The low pressure inside the pocket allows blood to accumulate freely with in the pocket. With fluid accumulation the pocket pressure increases causing marked pain and discomfort. As the pressure continues to increase, it also provides counter effect to leaking blood vessels from further bleeding (hemostasis). However, at that time the pocket is already filled with blood.

The present invention involves creation of an external counter pressure over the device pocket and incision. This allows the creation of hemostasis without the formation of a bleed in the pocket. Furthermore, it can also stabilize blood clot formation within the surgical site and may allow initiation of blood thinner much earlier during the course of the treatment. This can further reduce the pain associated with the implantation. Though an external pressure can be applied immediately after the procedure using a heavy object or a large tape, it is often uncomfortable or its removal may be painful, and in almost all cases, causes some irritation or allergic reaction. Furthermore, these measures are usually maintained for the first 24 hours at most and in a significant number of patients develop hematoma shortly after that. The present invention can be applied easily and comfortably immediately after the procedure and for a longer duration of time which will allow a constant pressure application and address the issues described above.

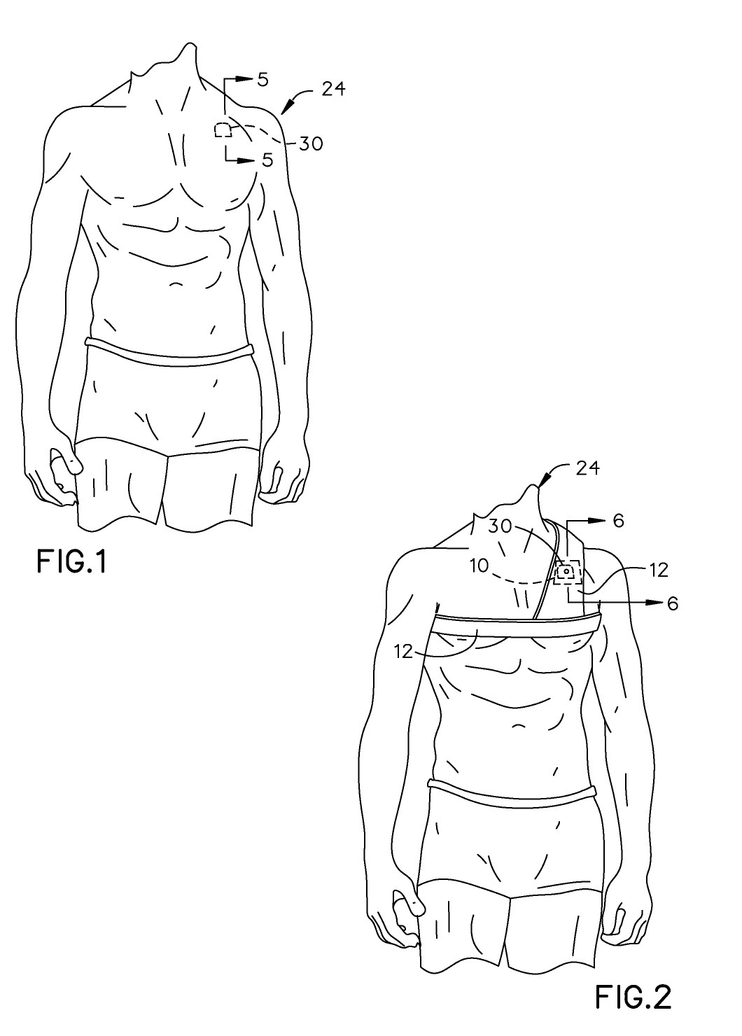

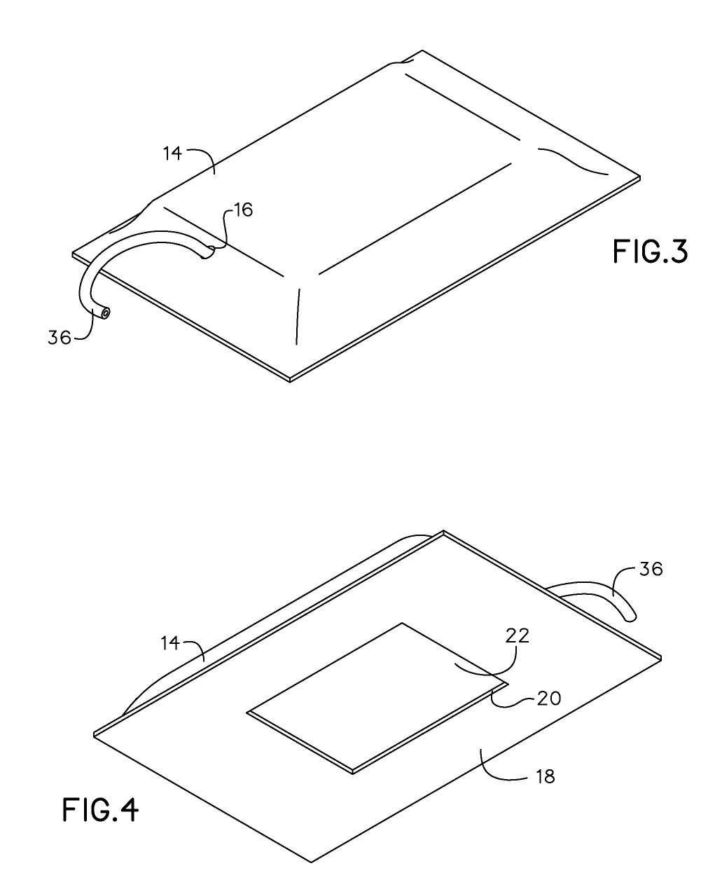

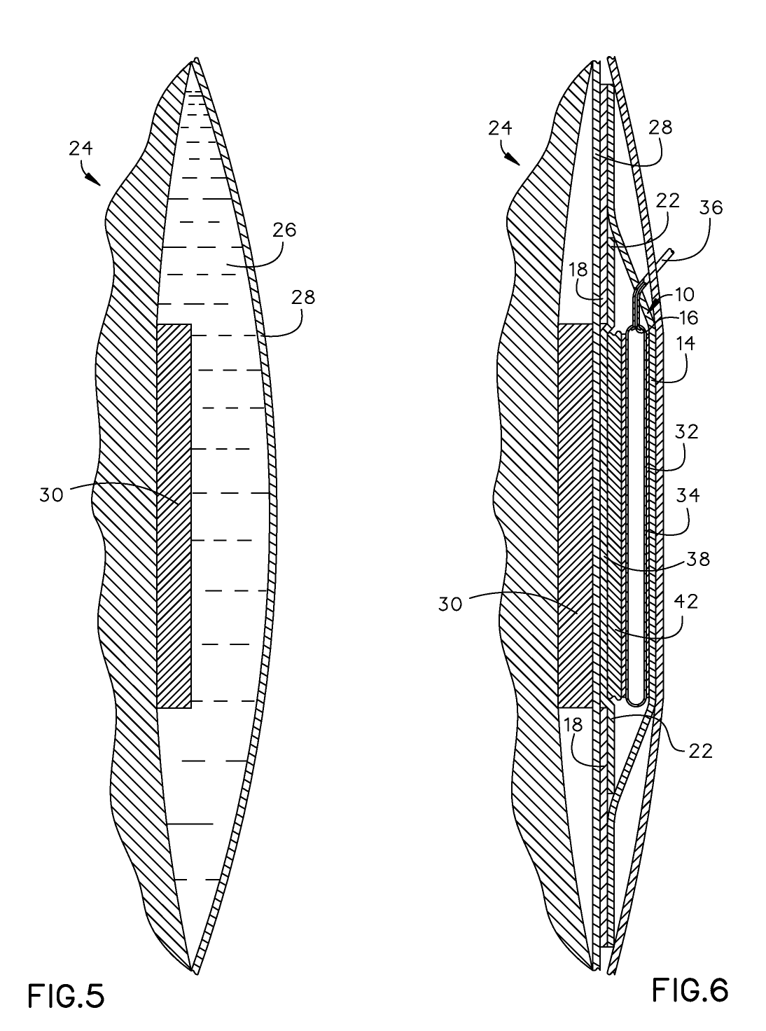

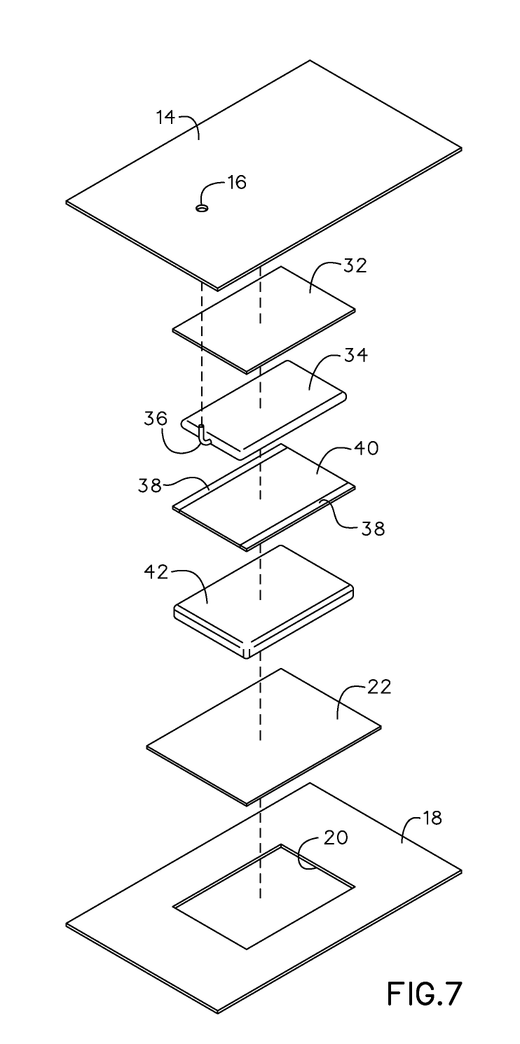

Referring to FIGS. 1 through 7, the present invention includes a pressure applying apparatus. The pressure applying apparatus includes a harness 12 that is securable to an upper torso of a user 24. The harness 12 includes a portion 10 positioned to be secured over an implant 30 of the user 24. An air bladder 34 is secured to the portion 10. The air bladder 34 includes a sidewall forming an internal housing where a gas is secured within. The air bladder 34 is adjustable and thereby includes a fill hose 36 running into the housing. The harness 12 may be secured to the user 24 and the air bladder 34 may be inflated with a gas via the fill hose 36 to apply pressure to the implant 30.

The harness 12 of the present invention may include a shoulder compression apron with a chest belt. The shoulder compression apron may include a first side and a second side each having front connector and a rear connector. The connectors may include a hook and loop fastener, i.e. Velcro®, snaps, clips and the like. The shoulder compression apron may further include the air bladder 34 embedded within. The chest belt may also include connectors that connect with the connectors of the shoulder compression apron. The chest belt may further include a metal belt loop and an elastic portion. The end of the strap of the chest belt may fit within the metal loop and attach to itself by the chest belt securement. The present invention may further include an adjustable arm support.

In certain embodiments, the air bladder 34 may be embedded within the harness 12. The air bladder 34 is secured to the harness 12 in between an inner harness fabric 18 facing towards the implant 30 and an outer harness fabric 14 facing away from the implant 30. The outer harness fabric 14 may include a hole 16 in which the fill hose 36 may run through, thereby providing easy access to the fill hose 36. In certain embodiments, the inner harness fabric 18 includes a cut out portion 20. An elastic layer 22 is secured to cover the cutout portion 20. Therefore, the air bladder 34 may easily expand and apply pressure to the implant 30, expanding against the elastic layer 22.

The file hose 36 of the present invention may be filled using a pump or by blowing into the fill hose 36. In certain embodiments, the present invention may include a quick disconnect check valve fitting. The check valve may be connected to the fill hose 36 or the air bladder 34. Therefore, the air pressure pumped into the air bladder 34 may be maintained. The manual air fill air bladder 34 may also have a quick disconnect fill fitting attached to the hose. The quick disconnect fill fitting is a valve that retains the air within the bladder 34.

The present invention may further include at least one rigid layer 32. The at least one rigid layer 32 is disposed in between the elastic layer 22 and the outer harness fabric 14. The at least one rigid layer 32 may allow the air bladder 34 to apply a focused and even pressure against the implant 30. In certain embodiments, the rigid layer 32 may be in between the air bladder 34 and the outer harness fabric 14.

The present invention may further include a flexible rigid layer. The flexible rigid layer includes a plurality of rigid strips 38 aligned parallel with one another. The rigid strips 38 are connected to together by a hinge or an adhesive 40 so that they may pivot relative to one another. The flexible rigid layer may be in between the air bladder 34 and the elastic layer 22. The flexible rigid layer may conform to the air bladder 36 to apply an even pressure.

The present invention may further include a foam pad 42. The foam pad 42 may be disposed in between the flexible rigid layer and the elastic layer 22. The foam pad 42 may further focus the pressure as well as provide comfort for the user 24.

A method of preventing hematoma 26 to an implant 30 may include the following. The harness 12 with the air bladder 34 mentioned above is provided The harness 12 is secured to the user 24 so that the air bladder 34 is secured over the skin 28 covering the implant 30. The user 24 may then inflate the bladder 34 with gas, thereby expanding the bladder 34. This may be done using an air pump. The air bladder 34 may thereby apply a pressure to the implanted device, preventing hematoma 26. Further, in certain embodiments, the air bladder 34 may be adjusted by inflating and deflating the internal housing.

It should be understood, of course, that the foregoing relates to exemplary embodiments of the invention and that modifications may be made without departing from the spirit and scope of the invention as set forth in the following claims.

What is claimed is:

1. A pressure applying apparatus comprising:
a harness securable to an upper torso of a user and comprising a portion positioned to be secured over an implantation of the user; and
an air bladder secured to the portion and comprising a sidewall forming an internal housing and a fill hose running into the housing, wherein the air bladder is operable to be filled with a gas to expand the sidewall and apply pressure to the implantation.

2. The pressure applying apparatus of claim 1, wherein the air bladder is secured to the harness in between an inner harness fabric facing towards the implantation and an outer harness fabric facing away from the implantation.

3. The pressure applying apparatus of claim 2, wherein the inner harness fabric comprises a cutout portion, wherein an elastic layer is secured to cover the cutout portion.

4. The pressure applying apparatus of claim 3, further comprising at least one rigid layer disposed in between the air bladder and the outer harness fabric.

5. The pressure applying apparatus of claim 3, further comprising a flexible rigid layer comprising a plurality of rigid strips aligned parallel to one another and hingedly connected together, wherein the flexible rigid layer is disposed in between the air bladder and the elastic layer.

6. The pressure applying apparatus of claim 5, further comprising a foam pad disposed in between the flexible rigid layer and the elastic layer.

7. A method of preventing hematoma to an implanted device comprising:
providing a harness comprising an air bladder;
securing the harness to a user so that the air bladder is secured over the implanted device; and
inflating the air bladder so that the air bladder applies pressure to the implanted device.

8. The method of claim 7, further comprising the step of: deflating the air bladder, and thereby adjusting the pressure applied to the implanted device.

9. The pressure applying apparatus of claim 7, wherein the air bladder is secured to the harness in between an inner harness fabric facing towards the implantation and an outer harness fabric facing away from the implantation.

10. The pressure applying apparatus of claim 8, wherein the inner harness fabric comprises a cutout portion, wherein an elastic layer is secured to cover the cutout portion.

11. The pressure applying apparatus of claim 10, further comprising at least one rigid layer disposed in between the air bladder and the outer harness fabric.

12. The pressure applying apparatus of claim 10, further comprising a flexible rigid layer comprising a plurality of rigid strips aligned parallel to one another and hingedly connected together, wherein the flexible rigid layer is disposed in between the air bladder and the elastic layer.

13. The pressure applying apparatus of claim 12, further comprising a foam pad disposed in between the flexible rigid layer and the elastic layer.
